(19) United States
(12) Patent Application Publication
(10) Pub. No.: US 2025/0278326 A1
(43) Pub. Date: Sep. 4, 2025

(54) ASSET OPERATION RECOMMENDATION BASED ON DYNAMIC & STATIC EVENT DETECTION AND PATTERN DISCOVERY FOR HIDDEN FAILURE ANALYSIS

(71) Applicant: HITACHI, Ltd., Tokyo (JP)

(72) Inventors: Shouchun PENG, Palo Alto, CA (US); Ravigopal VENNELAKANTI, San Jose, CA (US); Malarvizhi SANKARANARAYANASAMY, Mountain View, CA (US)

(21) Appl. No.: 18/593,713

(22) Filed: Mar. 1, 2024

(51) Int. Cl. G06F 11/07; G06F 16/22; G06F 16/248; G06F 16/28; G06F 40/58; G06N 3/0455

(52) U.S. Cl. CPC G06F 11/079; G06F 11/0709; G06F 16/2264; G06F 16/248; G06F 16/287; G06F 40/58; G06N 3/0455

(57) ABSTRACT

Example implementations described herein involve, for receipt of time series data from sensors of one or more assets in a system, executing feature extraction on the received time series data; identifying event types from the feature extraction; identifying pairs of event type and a window of the time series data; clustering motifs of the identified pairs to update a motif dictionary; estimating a likelihood of an event from the event types based on one or more discovered motifs from the time series data and an associated time series motif of the event; using a language model to generate associated event descriptions; providing, through a user interface, the estimated likelihood of the event, the associated time series motif, sequencing of the associated time series motif, and a recommendation; and for an acceptance of the recommendation through the user interface, executing the recommendation for the one or more assets in the system.

### BACKGROUND

### Field

The present disclosure is generally directed to failure analysis, and more specifically, to asset operation recommendation systems based on event detection and pattern discovery for hidden failure analysis.

### Related Art

The natural gas network in the oil and gas industry provides the pipeline to transport gas from producing wells to customers, which can involve gas compressor stations and other heavy machinery. Maintaining a health pipeline to transport natural gas is crucial for the oil and gas industry. Many factors such as friction, elevation variations, temperature, operations, and so on may lead to high or low pressure. In addition, the growth of the oil and gas sector drives the market expansion of the compressor businesses. With millions of producing wells in the United States alone, the adoption of the sensor or the Internet of Things (IoT) based solution and service is steadily growing. Therefore, huge demand for the natural gas compressor is anticipated to occur across the globe.

Since the growth of the IoT based solution and service integrated with the gas compressor business, many such compressors are located in remote and harsh environments, which makes routine maintenance an expensive overhead due to the labor shortages and operational knowledge gaps. Moreover, catastrophic failures create downtime and incur heavy cost to the gas compressor business. It is critical to understand the failure pattern or behavior, as well as to capture and digitalize knowledge assets that could benefit the operation. In addition to identifying the behavior, it is also necessary to classify and label the behavior to provide a reliable operation/task identification and recommend operational repair dispatch or monitoring services.

In the related art, there are systems and methods that facilitate large scale motif discovery and association with events. In such related art systems, there can be motif scaling recognition for early alerting, and motif learning and labelling systems.

### SUMMARY

Remote asset failure causes a significant business impact. Current prediction and alerting systems are not capable of providing hidden failure pattern discovery and event pattern association. For example, once a subset of trainable examples is visible to the user, the trained system can only detect those visible failure patterns. Hidden failure pattern identification is critical when dealing with assets operation. The operation related tasks specific to certain failure types need to be planned before assigning and dispatching engineers to the remote site.

In the related art, the task assignment has to be assigned manually with lots of unknown failure that causes operation redundancy. Example implementations described herein involve systems and methods that dynamically discover and associate the event that represents the failure pattern. In example implementations, the system translates the assets channel log into the labelled event and predicted failure patterns, and utilize the prediction of the failure patterns for remote asset alert and identification of task assignments.

In one issue with the related art, time series motifs are hard to recognize and detect. Although limited patterns can be found, there can be hidden patterns that cannot be recognized and are difficult to associate with an event, with potentially millions of failures are mostly classified as hidden patterns.

Another issue with the related art is that it can be difficult to associate different events (single or sequential) with failure types.

In another issue with the related art, due to the nature of the system being located in harsh environments, operation rerouting can be important. It is difficult to alert the operation ahead of time and plan for the failure type related operation.

Described herein are a system and method for task specific operation recommendation.

In example implementations described herein, there can be a function to detect all pairs of the patterns associated with arbitrary time frame and events, a learning system function that can detect the failure pattern, as well as a task identification function for automatic operation assignment without incurring a delay from requiring a human decision.

Example implementations further involve a data capturing system for time series data including data cleaning, data pipeline, feature extraction and utilizing the data set for identifying known and hidden failure patterns. The example implementations further provide an event collection module that can allow automatic event association with an arbitrary time frame and its specific failure pattern. The pattern can be single dimension or multi dimension across various time series data sets. A learning system utilizes the identified pattern dictionary to train the translation module to translate and label the time series with the associated event class.

Based on a given event the system predicts the likelihood of the occurrence of the next event. When a predicted time series channel log appears in the future time frame, the example implementations can provide an operation association task identification for the operation recommendation.

In a first aspect, there is a data capturing system for time series data, including feature extraction for the time series data set. The data capturing system identifies event types and associates with the corresponding time series data. The data capturing system identifies all pairs of patterns based on an arbitrary window and similar pattern with a time scale effect. In the data capturing system, there is a cluster motif and the system builds classes for the motif dictionary. The data capturing system can also facilitate the estimation of the likelihood of an event based on a given discovered pattern.

In a second aspect, there is also a component for failure pattern and event modeling and association. The event class updates when a new event has registered through feature generation.

In a third aspect, there is a learning system for the translation module. Such a system involves continuous time series labelling based on failure type and event.

Although example implementations are presented with respect to the oil and gas industry, the example implementations described herein can be extended to other fields that utilize IoT or data analytics systems, and the present disclosure is not limited thereto.

Aspects of the present disclosure can include a method, which can include, for receipt of time series data from sensors of one or more assets in a system, executing feature extraction on the received time series data; identifying event types from the feature extraction; identifying pairs of event type and a window of the time series data; clustering motifs of the identified pairs to update a motif dictionary; estimating a likelihood of an event from the event types based on one or more discovered motifs from the time series data and an associated time series motif of the event; providing, through a user interface, the estimated likelihood of the event, the associated time series motif, sequencing of the associated time series motif, and a recommendation; and for an acceptance of the recommendation through the user interface, executing the recommendation for the one or more assets in the system.

Aspects of the present disclosure can include a system, which can include, for receipt of time series data from sensors of one or more assets in a system, means for executing feature extraction on the received time series data; means for identifying event types from the feature extraction; identifying pairs of event type and a window of the time series data; means for clustering motifs of the identified pairs to update a motif dictionary; means for estimating a likelihood of an event from the event types based on one or more discovered motifs from the time series data and an associated time series motif of the event; means for providing, through a user interface, the estimated likelihood of the event, the associated time series motif, sequencing of the associated time series motif, and a recommendation; and for an acceptance of the recommendation through the user interface, means for executing the recommendation for the one or more assets in the system.

Aspects of the present disclosure can include a computer program, which can include instructions including, for receipt of time series data from sensors of one or more assets in a system, executing feature extraction on the received time series data; identifying event types from the feature extraction; identifying pairs of event type and a window of the time series data; clustering motifs of the identified pairs to update a motif dictionary; estimating a likelihood of an event from the event types based on one or more discovered motifs from the time series data and an associated time series motif of the event; providing, through a user interface, the estimated likelihood of the event, the associated time series motif, sequencing of the associated time series motif, and a recommendation; and for an acceptance of the recommendation through the user interface, executing the recommendation for the one or more assets in the system. The computer program and instructions can be stored on a non-transitory computer readable medium and executed by one or more processors.

Aspects of the present disclosure can include an apparatus, which can include a processor, configured to, for receipt of time series data from sensors of one or more assets in a system, execute feature extraction on the received time series data; identify event types from the feature extraction; identify pairs of event type and a window of the time series data; cluster motifs of the identified pairs to update a motif dictionary; estimate a likelihood of an event from the event types based on one or more discovered motifs from the time series data and an associated time series motif of the event; provide, through a user interface, the estimated likelihood of the event, the associated time series motif, sequencing of the associated time series motif, and a recommendation; and for an acceptance of the recommendation through the user interface, execute the recommendation for the one or more assets in the system.

### BRIEF DESCRIPTION OF DRAWINGS

FIG. 1 illustrates an example system in accordance with an example implementation.

FIG. 2 illustrates examples of patterns discovered under different time windows, in accordance with an example implementation.

FIG. 3 is a flowchart of the overall system flow, in accordance with an example implementation.

FIG. 4 is an illustration of the encoder-decoder model, in accordance with an example implementation.

FIG. 5 illustrates an example of pattern event mapping and significance test on the dataset, in accordance with an example implementation.

FIG. 6 illustrates an example flow to generate the significance result, in accordance with an example implementation.

FIG. 7 illustrates an example of a projected series, in accordance with an example implementation.

FIG. 8 illustrates an example of motif discovery, in accordance with an example implementation.

FIG. 9 illustrates an example of multi-dimensional motifs and labels, in accordance with an example implementation.

FIG. 10 illustrates an example flow to determine the next possible failure pattern and event, in accordance with an example implementation.

FIG. 11 illustrates a plurality of physical systems that are networked to a management apparatus, in accordance with an example implementation.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

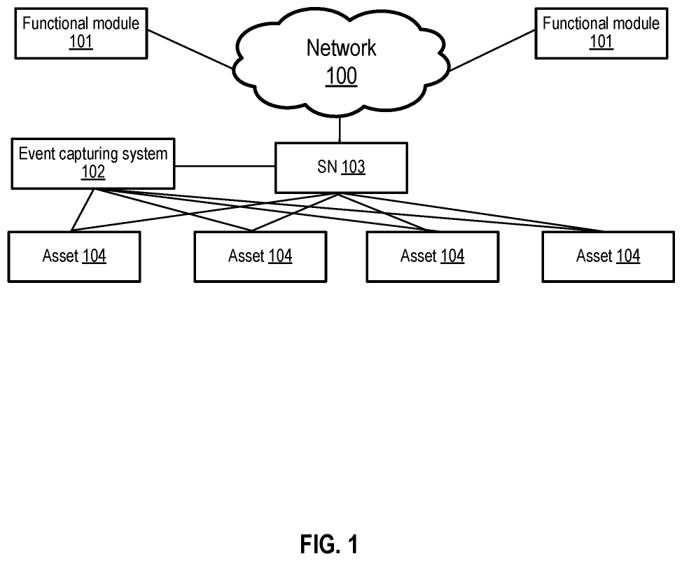

FIG. 1 illustrates an example system, in accordance with an example implementation. In example implementations, the asset time series data may be received from sensor channel logs, such as from data collectors, remote monitoring systems, tracking devices, asset management systems, or other communication technology. Each of the assets 104 can involve any asset in accordance with the desired implementation, such as, but not limited to, a compressor such as an industrial air compressor, a turbine or engine, compressor SKID packages, and so on. Such assets can be connected to a server node (SN) 103, which can facilitate an event capturing system 102. Depending on the desired implementation, the server node 103 can also be connected to a network 100 such as a wide area network (WAN) to facilitate additional functional computations by functional modules 101. Functional modules 101 can be cloud-based functions that are called upon by the server node 103.

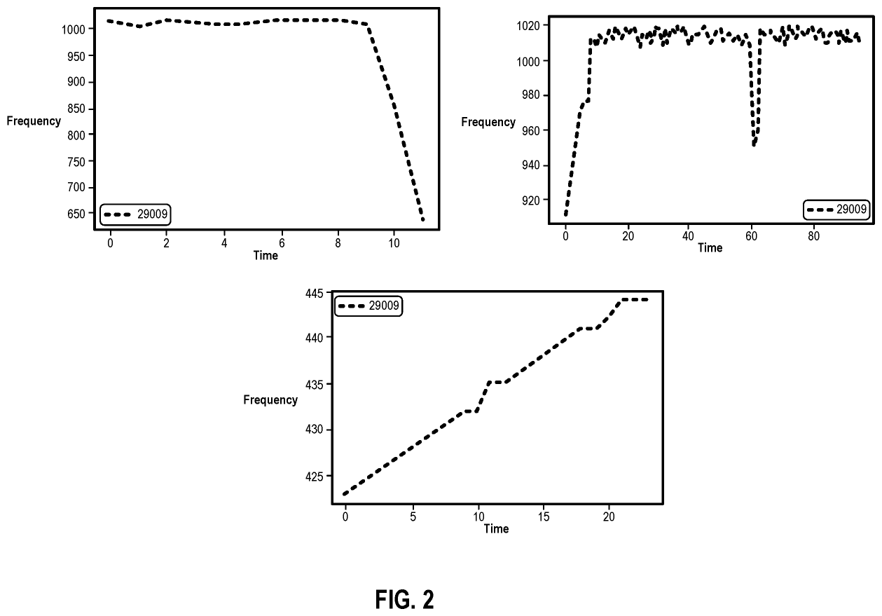

The system in the example implementations provide a time series pattern discovery, learning, and labelling for the asset operation recommendation system. The pattern discovery function is calculated by distance-based similarity function between single dimension pattern(s) or multi-dimension patterns. The system detects patterns in time series dataset and extracts pattern features from an arbitrary length of time series data. FIG. 2 are examples of patterns discovered under different time windows, in accordance with an example implementation. The system collects time series events (shutdown, high pressure alert, low pressure alerts, and so on) from the event management system or channel logs. The events are associated with discovered pattern(s) based on the time when the event occurred.

Example implementations described herein further involve a labeling function that is configured to utilize a sequence to sequence language model trained based on an association between the time series discovered pattern and the event description. The model describes the description of the event associated with the time-series pattern such as “there is an increase of the temperature signals”.

In the example implementations described herein, there are patterns of the time series data that are discovered and assigned to specific events. The patterns are discovered by pattern mining techniques from various time series data, and the time series may be single-dimension series or multi-dimension series across related channel logs. Discovered patterns may be associated with time series event(s) that are under an arbitrary time frame. The system performs clustering for the discovered patterns to provide the final output to the pattern dictionary.

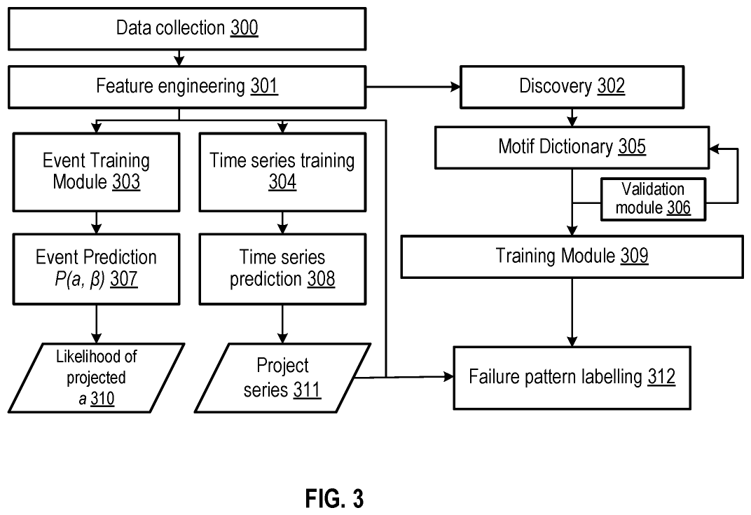

FIG. 3 is a flowchart of the overall system flow, in accordance with an example implementation. The system begins with a data collection process 300 to collect data from the underlying assets. The data undergoes a process of feature engineering 301 to conduct discovery 302 of patterns using pattern mining techniques from the data. The extracted features are also used to train algorithms such as an event training module 303 that is configured to train a machine learning model to predict events 307, and a time series training module 304 that is configured to train a machine learning model to conduct time series prediction 308. The predicted events 307 can indicate the likelihood of a projected event 310. The time series prediction 308 can be configured to provide a projected series 311 indicating future time series data that is expected.

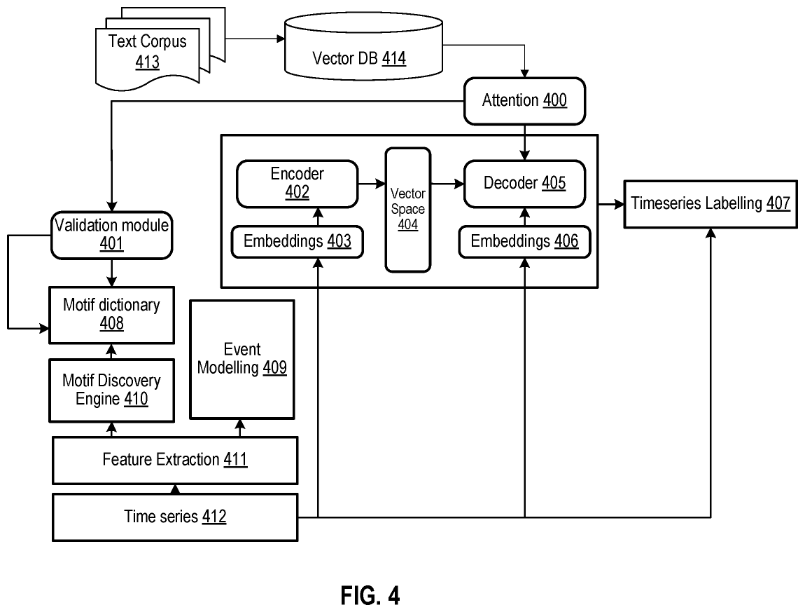

The patterns discovered through the discovery process 302 is then added to the motif dictionary 305. Motifs included in the motif dictionary 305 can be validated by the validation module 306 based on received validation from the failure pattern labelling 312. Training module 309 is configured to conduct failure pattern labelling 312 based on the motifs included from the motif dictionary 305. In example implementations, the training module 309 incorporates a natural language model and/or other extended language models that associates projected time series projections 311 and motifs from motif dictionary 305 into an event description and recommendation. The training module can utilize a text corpus to form a vector database to learn the associations for generating recommendations as illustrated with respect to FIG. 4.

FIG. 4 is an illustration of the encoder-decoder model, in accordance with an example implementation. At first, time series data 412 is provided to feature extraction 411 to extract features. The extracted features are provided to event modelling 409 to identify events, and motif discovery engine 410 to discover motifs, which can be placed in the motif dictionary 408.

The time series data 412 are then pre-processed with embeddings 403, 406 to be ingested by the encoder 402 and decoder 405. The encoder 402 encodes the embedded time series data into vector space 404. Decoder 405 is also set at attention 400 based on identified motifs, in creating the output for the timeseries labelling 407. The alert is also provided to the validation module 401 to validate the motif dictionary 408.

In addition, available text corpus 413 can be used to form a vector database 414. The vector database 414 is then used to train a natural language model and/or other extended language models that is configured to intake motifs or time series sequences and convert them into natural language to be used at attention 400, thereby creating natural language output.

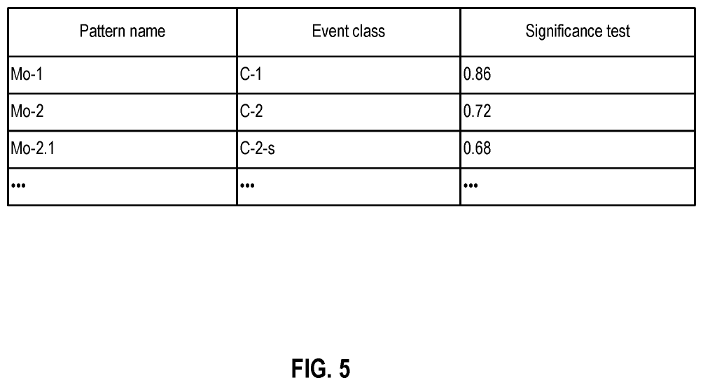

FIG. 5 illustrates an example of pattern event mapping and significance test on the dataset, in accordance with an example implementation. As shown in FIG. 5, each pattern can be associated with a pattern name, an event class, and a significance test.

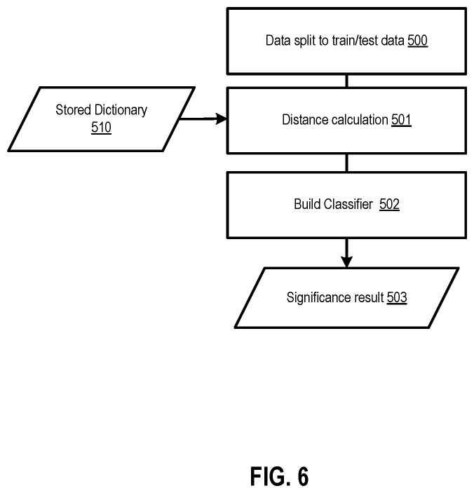

FIG. 6 illustrates an example flow to generate the significance result, in accordance with an example implementation. At 500, the data is split into training data and test data. At 501 a distance calculation is conducted on the labeled training data based on the stored dictionary 510 of patterns. At 502, a classifier is then constructed to learn the distances from the pattern in the stored dictionary and the labeled training data to output a significance result 503, patterns based on the distance calculation for the training data. At 503, the significance result is provided for each of the patterns in the stored dictionary to generate the pattern event mapping and the significance test.

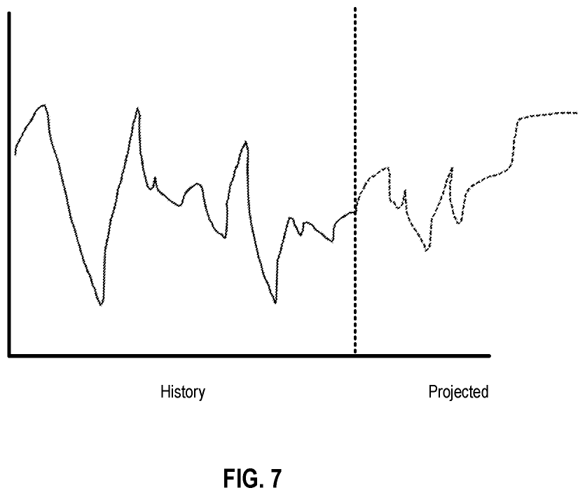

FIG. 7 illustrates an example of a projected series, in accordance with an example implementation. Specifically, FIG. 7 illustrates an example in which historical data is provided to the encoder 402, wherein the decoder 405 generates a projected series based on the encoded historical data. The projected series can be labeled with motifs or sequences of identified motifs. Once the data collection and pattern feature engineering are captured, the example implementations perform an estimation of the conditional probability of a given pattern, as well as what event will occur in the projected timeline. The example implementations can estimate the likelihood that selected events occur and extract the associated event time window based on the pattern dictionary.

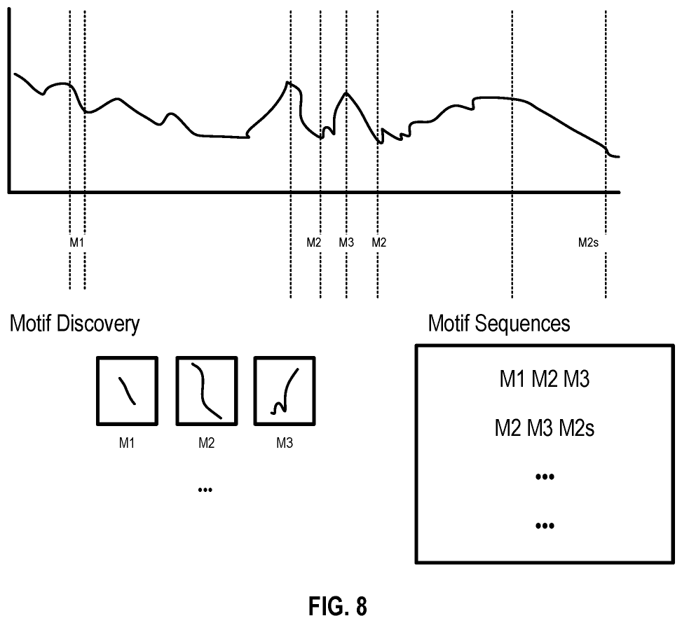

FIG. 8 illustrates an example of motif discovery, in accordance with an example implementation. As shown in FIG. 8, based on the extracted features, motifs are discovered and added into the motif dictionary. Sequences of motifs can also be identified and stored in the motif dictionary.

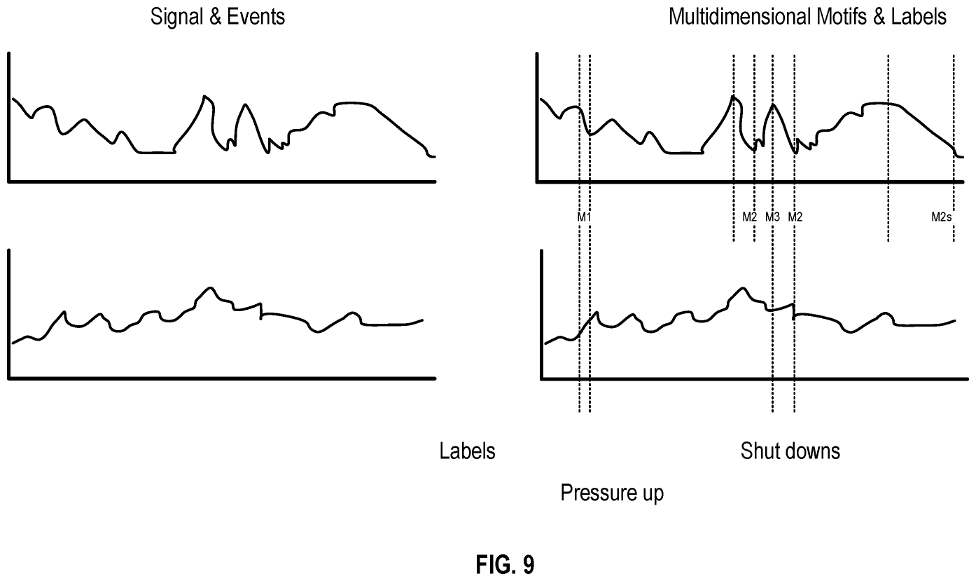

FIG. 9 illustrates an example of multi-dimensional motifs and labels, in accordance with an example implementation. From the signal and events, motifs are identified, along with corresponding labels for the events. For example, the M1 motif is identified with the label of pressure going up. The sequence of motifs M3 followed by M2 indicates shut downs.

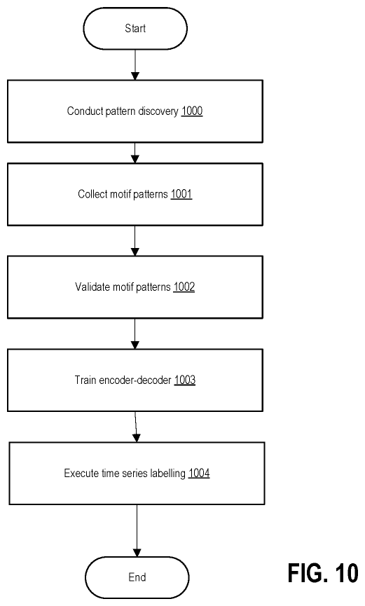

FIG. 10 illustrates an example flow to determine the next possible failure pattern and event, in accordance with an example implementation. In order to alert the next possible failure pattern and event, the system utilizes the channel logs to train a time series prediction model for the next window time series. In the machine translation phase, the following steps can be involved. At 1000, pattern discovery is conducted to find all pairs of patterns associated with time windows and find the alignment between different time dependent events. Next at 1001, all motif patterns are collected and event classes are associated to the motif patterns based on the anchored time stamp. Then at 1002, validation is conducted by the validation module in which a classifier for validation for the significance test of collected motif patterns is executed. Subsequently at 1003, a step is conducted by the training module in which an encoder-decoder model for time series network model extracts the time series channel logs and trains a model that translate the next possible patterns with a specific time window. Finally, at 1004, time series labelling is executed that inputs the projected time series data and uses the model from the training module to label the entire time series data.

Through the example implementations described herein, there can be hidden failure and sequencing identification, as well as event/task operation identification with better knowledge. The example implementations can also facilitate operators to plan ahead for operation recommendations.

Example implementations can be applied to task and operation planning in the oil and gas industry and for failure pattern alert planning in oil and gas construction business.

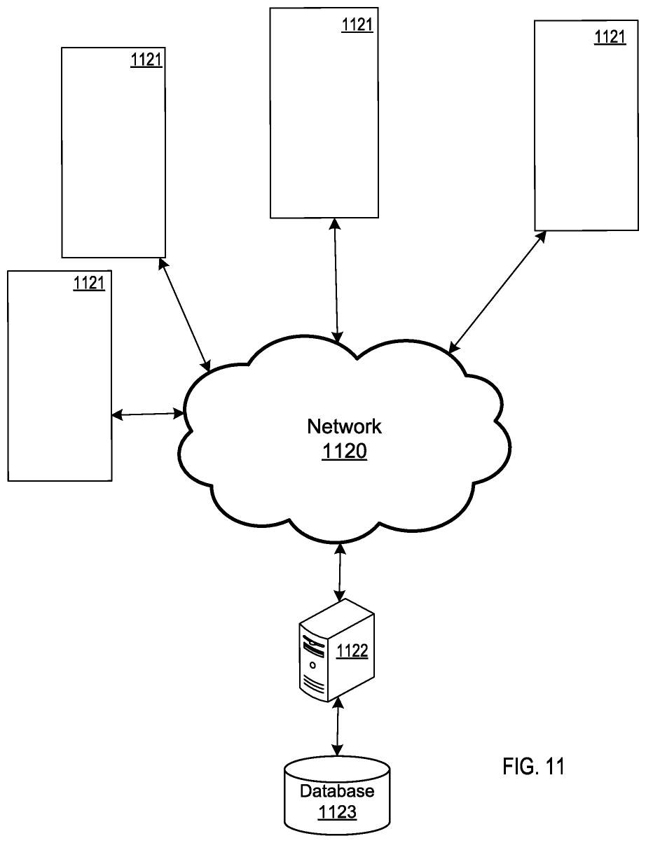

FIG. 11 illustrates a plurality of physical systems that are networked to a management apparatus, in accordance with an example implementation. One or more physical systems 1121 (e.g., air compressors, equipment (e.g., oil rigs, rig drills, trucks, sensor-based recorders) or other assets according to the desired implementation) are communicatively coupled to a network 1120 (e.g., local area network (LAN), wide area network (WAN)) through the corresponding network interface of the sensor system installed in the physical systems 1121, which is connected to a management apparatus 1122. The one or more systems 1121 may or may not be associated with sensors, depending on the desired implementation. The management apparatus 1122 manages a database 1123, which contains historical data collected from the sensor systems from each of the physical systems 1121. In alternate example implementations, the data from the sensor systems of the physical systems 1121 can be stored in a central repository or central database such as proprietary databases that intake data from the physical systems 1121, or systems such as enterprise resource planning systems, and the management apparatus 1122 can access or retrieve the data from the central repository or central database. The sensor systems of the physical systems 1121 can include any type of sensors to facilitate the desired implementation, such as but not limited to gyroscopes, accelerometers, global positioning satellite (GPS), thermometers, humidity gauges, or any sensors that can measure one or more of temperature, humidity, gas levels (e.g., CO2 gas), and so on. As described herein, the management apparatus 1122 can be configured to reach external servers to obtain pertinent weather data.

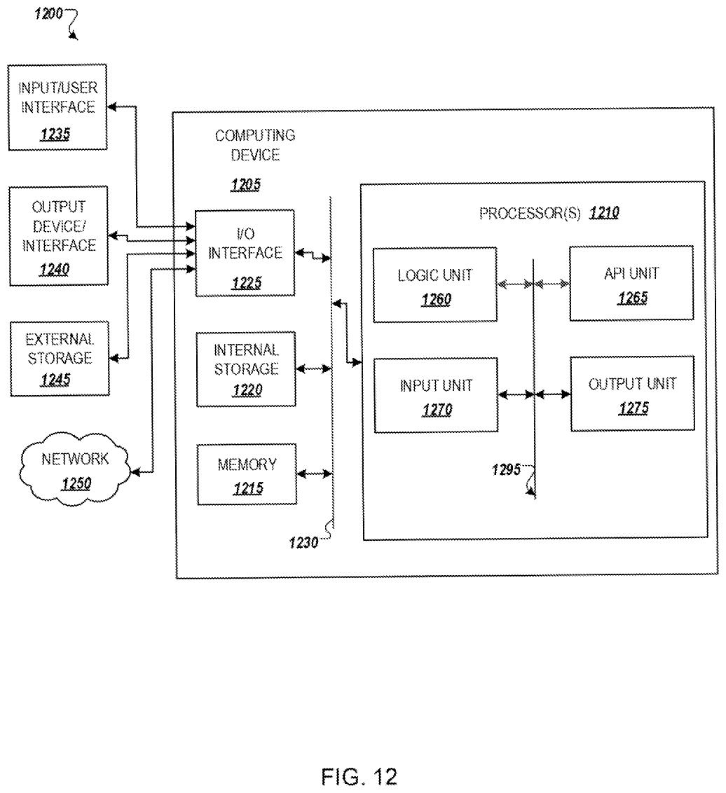

FIG. 12 illustrates an example computing environment with an example computer device suitable for use in some example implementations, such as a management apparatus 1122 as illustrated in FIG. 11. Computer device 1205 in computing environment 1200 can include one or more processing units, cores, or processors 1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configurations. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in the example implementations.

Processor(s) 1210 can be configured to execute a method or instructions, which can involve, for receipt of time series data from sensors of one or more assets in a system, executing feature extraction on the received time series data; identifying event types from the feature extraction; identifying pairs of event type and a window of the time series data; clustering motifs of the identified pairs to update a motif dictionary; estimating a likelihood of an event from the event types based on one or more discovered motifs from the time series data and an associated time series motif of the event; providing, through a user interface, the estimated likelihood of the event, the associated time series motif, sequencing of the associated time series motif, and a recommendation; and for an acceptance of the recommendation through the user interface, executing the recommendation for the one or more assets in the system.

Processor(s) 1210 can be configured to execute the method or instructions above, wherein the clustering motifs of the identified pairs to update the motif dictionary includes executing a significance test to identify unknown motifs for updating the motif dictionary.

Depending on the desired implementation, the window can be an arbitrary window or a designated window.

Processor(s) 1210 can be configured to execute the method or instructions above, and further involve validating the motif dictionary from the identified event types from the feature extraction corresponding to the clustered motifs; and executing a machine learning algorithm to provide labels associated with the associated time series motif.

Processor(s) 1210 can be configured to execute the method or instructions above, wherein the machine learning algorithm is configured to provide natural language translation associated with the associated time series motif; wherein the machine learning algorithm is trained from time-series sequences utilizing a language model with associated training data to output the natural language translation for time series motifs.

Processor(s) 1210 can be configured to execute the method or instructions above, wherein the time series data is across a plurality of different sensors, wherein the clustering of motifs is conducted on the time series data across the plurality of different sensors to form multi-dimensional motifs.

Processor(s) 1210 can be configured to execute a language model configured to output a natural language event description for the event, the language model trained an association between time series patterns, motifs, and event descriptions, wherein the recommendation is generated from a recommendation machine learning model that intakes the event description for the event and the estimated likelihood of the event to output the recommendation.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of time series data from sensors of one or more assets in a system:
executing feature extraction on the received time series data;
identifying event types from the feature extraction;
identifying pairs of event type and a window of the time series data;
clustering motifs of the identified pairs to update a motif dictionary;
estimating a likelihood of an event from the event types based on one or more discovered motifs from the time series data and an associated time series motif of the event;
providing, through a user interface, the estimated likelihood of the event, the associated time series motif, sequencing of the associated time series motif, and a recommendation; and
for an acceptance of the recommendation through the user interface, executing the recommendation for the one or more assets in the system.

2. The method of claim 1, wherein the clustering motifs of the identified pairs to update the motif dictionary comprises executing a significance test to identify unknown motifs for updating the motif dictionary.

3. The method of claim 1, wherein the window is an arbitrary window.

4. The method of claim 1, wherein the window is a designated window.

5. The method of claim 1, further comprising validating the motif dictionary from the identified event types from the feature extraction corresponding to the clustered motifs; and
executing a machine learning algorithm to provide labels associated with the associated time series motif.

6. The method of claim 5, wherein the machine learning algorithm is configured to provide natural language translation associated with the associated time series motif;
wherein the machine learning algorithm is trained from time-series sequences utilizing a language model with associated training data to output the natural language translation for time series motifs.

7. The method of claim 1, wherein the time series data is across a plurality of different sensors, wherein the clustering of motifs is conducted on the time series data across the plurality of different sensors to form multi-dimensional motifs.

8. The method of claim 1, further comprising executing a language model configured to output a natural language event description for the event, the language model trained an association between time series patterns, motifs, and event descriptions, wherein the recommendation is generated from a recommendation machine learning model that intakes the event description for the event and the estimated likelihood of the event to output the recommendation.

9. A non-transitory computer readable medium, storing instructions for executing a process, the instructions comprising:
for receipt of time series data from sensors of one or more assets in a system:
executing feature extraction on the received time series data;
identifying event types from the feature extraction;
identifying pairs of event type and a window of the time series data;
clustering motifs of the identified pairs to update a motif dictionary;
estimating a likelihood of an event from the event types based on one or more discovered motifs from the time series data and an associated time series motif of the event;
providing, through a user interface, the estimated likelihood of the event, the associated time series motif, sequencing of the associated time series motif, and a recommendation; and
for an acceptance of the recommendation through the user interface, executing the recommendation for the one or more assets in the system.

10. The non-transitory computer readable medium of claim 9, wherein the clustering motifs of the identified pairs to update the motif dictionary comprises executing a significance test to identify unknown motifs for updating the motif dictionary.

11. The non-transitory computer readable medium of claim 9, wherein the window is an arbitrary window.

12. The non-transitory computer readable medium of claim 9, wherein the window is a designated window.

13. The non-transitory computer readable medium of claim 9, the instructions further comprising validating the motif dictionary from the identified event types from the feature extraction corresponding to the clustered motifs; and
executing a machine learning algorithm to provide labels associated with the associated time series motif.

14. The non-transitory computer readable medium of claim 13, wherein the machine learning algorithm is configured to provide natural language translation associated with the associated time series motif;
wherein the machine learning algorithm is trained from time-series sequences utilizing a language model with associated training data to output the natural language translation for time series motifs.

15. The non-transitory computer readable medium of claim 9, wherein the time series data is across a plurality of different sensors, wherein the clustering of motifs is conducted on the time series data across the plurality of different sensors to form multi-dimensional motifs.

16. The non-transitory computer readable medium of claim 9, the instructions further comprising executing a language model configured to output a natural language event description for the event, the language model trained an association between time series patterns, motifs, and event descriptions, wherein the recommendation is generated from a recommendation machine learning model that intakes the event description for the event and the estimated likelihood of the event to output the recommendation.

17. An apparatus, comprising:
a processor, configured to:
for receipt of time series data from sensors of one or more assets in a system:
execute feature extraction on the received time series data;
identify event types from the feature extraction;
identify pairs of event type and a window of the time series data;
cluster motifs of the identified pairs to update a motif dictionary;
estimate a likelihood of an event from the event types based on one or more discovered motifs from the time series data and an associated time series motif of the event;
provide, through a user interface, the estimated likelihood of the event, the associated time series motif, sequencing of the associated time series motif, and a recommendation; and
for an acceptance of the recommendation through the user interface, executing the recommendation for the one or more assets in the system.
